(19) United States
(12) Patent Application Publication
(10) Pub. No.: US 2012/0139799 A1
(43) Pub. Date: Jun. 7, 2012

(54) Method for Saving Terminal Electricity and Terminal

(75) Inventors: Bing Zhang, Shenzhen (CN); Xi Yang, Shenzhen (CN); Xin Wei, Shenzhen (CN)

(73) Assignee: ZTE CORPORATION, Shenzhen City, Guangdong Province (CN)

(21) Appl. No.: 13/258,447

(22) PCT Filed: May 24, 2010
(86) PCT No.: PCT/CN2010/073149

§ 371 Date: Dec. 18, 2011

(30) Foreign Application Priority Data
Aug. 25, 2009 (CN) 200910091780.4

(51) Int. Cl. H01Q 1/24

(52) U.S. Cl. 343/702

(57) ABSTRACT

A method for saving power of terminal is disclosed by the present invention. The method comprises: a control unit being connected with a radio frequency unit when a telescopic antenna is in a pulled-out state; and the control unit is disconnected from the radio frequency unit when the telescopic antenna is in a retraction state. A terminal is also provided by the present invention, terminal power consumption can be reduced based on said method and said terminal, so as to achieve the purpose of saving the battery power.

### TECHNICAL FIELD

The present invention relates to the communication field, and particularly, to a method for saving power of terminal and a terminal.

### BACKGROUND OF THE RELATED ART

Mobile terminals such as mobile phones, data cards as daily communication tools for people are already very popular, and the functions and performances thereof become more powerful, for example, a color screen, a high resolution, Bluetooth, a smart operating system etc. for the mobile phones, and various standards with more powerful functions such as General Packet Radio Service (GPRS), Enhanced Data Rate for GSM Evolution (EDGE), High Speed Downlink Packet Access (HSDPA), High Speed Uplink Packet Access (HSUPA) etc. for the data cards. The more powerful and abundant functions and performances of the mobile terminals such as mobile phones, data cards make the power consumption of the mobile terminals increase. On the other hand, for the mobile terminals such as 2G, 3G and 4G mobile phones, data cards, it is necessary to use a telescopic antenna due to restrictions such as the environment, appearances etc. When the antenna is pulled out, the power amplification of these mobile terminals which use the telescopic antenna is often in a better operating state, and the power consumption is substantially normal; when the telescopic antenna is retracted, the power amplification is substantially in a mismatch state, and at this time, the power consumption is much higher than that when the telescopic antenna is pulled out, and this power consumption is unnecessary, which wastes the battery power of the mobile terminals.

Currently, the general solution is to increase the capacity of batteries of the mobile terminals, while the bottleneck of the battery technology makes standby time of the mobile terminals very limited, resulting in a sharp decline of the battery power after the mobile terminals are frequently used, which makes the mobile terminals loss deserved basic functions, and affects the use of mobile terminals. Therefore, how to reduce the power consumption so as to save the battery power of the mobile terminals becomes an urgent problem to be solved.

### SUMMARY OF THE INVENTION

In view of this, the main purpose of the present invention is to provide a method for saving power of terminal and a terminal, which can reduce the power consumption of the terminal to achieve the purpose of saving the battery power.

In order to achieve the above propose, the technical solution of the present invention can be implemented as follows:

The present invention provides a terminal, which comprises: a telescopic antenna, a control unit and a radio frequency unit, wherein,

the telescopic antenna is used to generate a pulled-out or retraction state;

the control unit is used to be connected with or disconnected from the radio frequency unit according to the pulled-out or retraction state of the telescopic antenna; and

the radio frequency unit is used to be connected with or disconnected from the control unit.

The terminal further comprises a detection circuit unit and a feedback signal contact, wherein,

the detection circuit unit is used to output a high level to a programming controllable input and output (GPIO) interface of the control unit;

the feedback signal contact is connected with the GPIO interface of the control unit, and is used to be disconnected from the telescopic antenna and be in a high level state together with the GPIO interface when the telescopic antenna is in a pulled-out state, and to be connected with the telescopic antenna and be in a low level state together with the GPIO interface when the telescopic antenna is in a retraction state; and

the telescopic antenna and the feedback signal contact are located at the telescopic antenna unit.

The detection circuit unit further comprises: a pull-up resistor and a power supply.

The power supply outputs a high level to the GPIO interface through the pull-up resistor.

The detection circuit unit further comprises a parallel inductor and the telescopic antenna unit further comprises an antenna feed point;

The parallel inductor is connected with the antenna feed point; and the antenna feed point is connected with the telescopic antenna;

The parallel inductor is used to match the operating impedances of the telescopic antenna and the radio frequency unit and achieve the interaction between the radio frequency unit by a high frequency signal and the telescopic antenna through the antenna feed point when the telescopic antenna is in the pulled-out state; and the parallel inductor and the antenna feed point are used to achieve the connection between the GPIO interface and the ground when the telescopic antenna is in the retraction state.

The control unit is further used to be connected with or disconnected from the radio frequency unit according to the high level or low level state of the GPIO interface;

the radio frequency unit is further used to become into an opening state and interact with the telescopic antenna by the high frequency signal when being connected with the control unit, and become into a closing state when being disconnected from the control unit;

accordingly, the telescopic antenna is further used to transform the received high frequency signal into a wireless signal for transmission when the radio frequency unit becomes into an opening state, and is further used to transform the received wireless signal into a high frequency signal and provide it to the radio frequency unit.

The present invention further provides a method for saving power of terminal, which comprises:

a control unit being connected with a radio frequency unit when a telescopic antenna is in a pulled-out state; and

the control unit being disconnected from the radio frequency unit when the telescopic antenna is in a retraction state.

The method further comprises: a power supply of a detection circuit unit outputting a high level to a GPIO interface of the control unit through a pull-up resistor continually;

accordingly, when the telescopic antenna is in a pulled-out state, the method further comprises: the telescopic antenna being disconnected from a feedback signal contact, and the GPIO interface and the feedback signal contact connected therewith being in a high level state;

when the telescopic antenna is in a retraction state, the method further comprises: the telescopic antenna being connected with the feedback signal contact, and the GPIO interface and the feedback signal contact connected therewith being in a low level state.

Further, the GPIO interface and the feedback signal contact being in the low level state, particularly,

the GPIO interface is connected with the telescopic antenna through the feedback signal contact according to the conductive properties of metal materials of the telescopic antenna when the telescopic antenna is connected with the feedback signal contact, and the GPIO interface is connected with the ground through the antenna feed point connected with the telescopic antenna according to the direct-current conductive properties of the parallel inductor in the detection circuit unit, and the GPIO interface and the feedback signal contact are in a low level state.

Further, the control unit being connected with the radio frequency unit particularly is that the control unit is connected with the radio frequency unit according to the high level state of the GPIO interface.

After the control unit is connected with the radio frequency unit, the method further comprises:

opening the radio frequency unit;

accordingly, the radio frequency unit transforming the low frequency signal provided by the control unit into a high frequency signal, and providing it to the telescopic antenna; after transforming the high frequency signal into a wireless signal, the telescopic antenna transmitting the wireless signal;

alternatively, after transforming the received wireless signal into a high frequency signal, the telescopic antenna providing it to the radio frequency unit; after transforming the high frequency signal into a low frequency signal, the radio frequency unit providing it to the control unit for processing.

Further, the radio frequency unit providing the high frequency signal to the telescopic antenna or the telescopic antenna providing the high frequency signal to the radio frequency unit particularly is that

after matching the operating impedances of the telescopic antenna and the radio frequency unit by the parallel inductor of the detection circuit unit, the radio frequency unit providing the high frequency signal to the telescopic antenna through the antenna feed point connected with the telescopic antenna, or the telescopic antenna providing the high frequency signal to the radio frequency unit through the antenna feed point.

Further, the control unit being disconnected from the radio frequency unit particularly is that the control unit is disconnected from the radio frequency unit according to the low level state of the GPIO interface.

After the control unit is disconnected from the radio frequency unit, the method further comprises: closing the radio frequency unit.

In the solution of power saving of the present invention, the control unit controls the opening of the radio frequency unit and transmits and receives the wireless signal through the telescopic antenna when the telescopic antenna is pulled out; and the control unit controls the closing of the radio frequency unit, and the terminal is also in a standby or off state when the telescopic antenna is retracted. This can minimize the power consumption of the radio frequency unit, so as to save the battery power of the terminal.

### BRIEF DESCRIPTION OF DRAWINGS

FIG. 1 is a flowchart of the method for saving power of terminal of the present invention;

FIG. 2 is an internal structure diagram of the terminal when the telescopic antenna is pulled out;

FIG. 3 is an internal structure diagram of the terminal when the telescopic antenna is retracted;

FIG. 4 illustrates a structural diagram of the terminal to which the method for saving power of terminal is adapted.

### PREFERRED EMBODIMENTS OF THE PRESENT INVENTION

The technical solution of the present invention is further described in detail in combination with the accompanying drawings and embodiments hereinafter.

The solution of saving power of terminal of the present invention is to control the opening or closing state of the radio frequency unit according to the pulled-out or retraction state of the telescopic antenna, to achieve the purpose of reducing the power consumption of the terminal and saving the battery power.

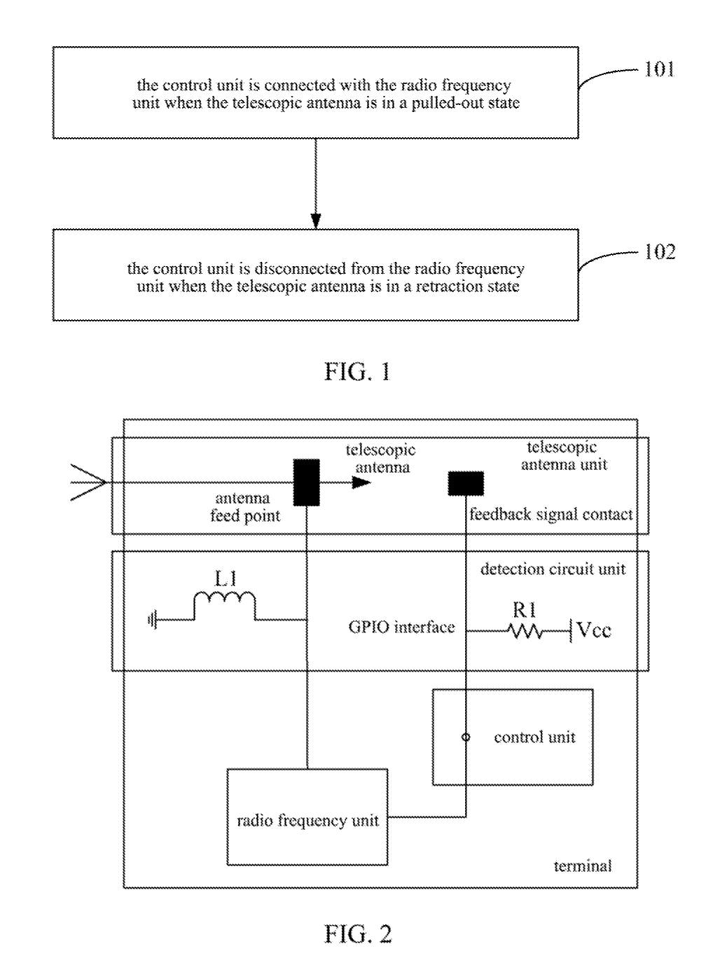

FIG. 1 is a flow of the method for saving power of terminal of the present invention, which comprises:

Step 101: the control unit being connected with the radio frequency unit when the telescopic antenna is in a pulled-out state;

Step 102: the control unit being disconnected from the radio frequency unit when the telescopic antenna is in a retraction state.

The solution of saving power of the present invention will be illustrated in combination with the internal structure of the terminal hereinafter.

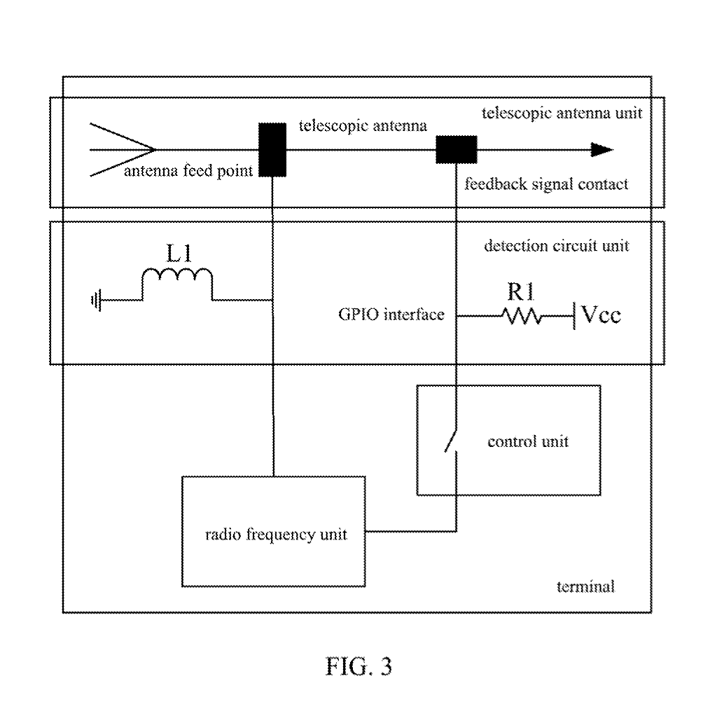

FIG. 2 is an internal structure diagram of the terminal when the telescopic antenna is pulled out; and FIG. 3 is an internal structure diagram of the terminal when the telescopic antenna is retracted. Wherein, the telescopic antenna unit comprises a telescopic antenna, an antenna feed point and a feedback signal contact. The feedback signal contact is connected with the programming controllable input and output (GPIO) interface of the control unit, the GPIO interface is further connected with a power supply Vcc through the pull-up resistor R1 of a detection circuit unit, and the power supply Vcc outputs a high level to the GPIO interface through R1 continually.

Step 101 will be illustrated in detail in combination with FIG. 2 hereinafter. As shown in FIG. 2, the telescopic antenna is disconnected from a feedback signal contact when the telescopic antenna is pulled out; meanwhile, both the GPIO interface and the feedback signal contact are in a high level state. The control unit is connected with the Radio frequency unit according to the high level state of the GPIO interface, and outputs the low frequency signal such as the audio frequency to the radio frequency unit, which will be transformed into a high frequency signal. The radio frequency unit is in an opening state, and at this time, the corresponding terminal is in an operating state. The high frequency signal reaches the telescopic antenna through the antenna feed point of the detection circuit unit, and the telescopic antenna transforms the high frequency signal into a wireless signal in the form of electro-magnetic wave for transmission. Alternatively, after transforming the received wireless signal into a high frequency signal which can be processed by the radio frequency unit, the telescopic antenna transmits the transformed signal to the radio frequency unit through the antenna feed point. After transforming the high frequency signal into a low frequency signal again, the radio frequency unit provides this transformed signal to the control unit for processing and the reception of the wireless signal is completed.

In this process, the parallel inductor L1 of the detection circuit unit plays a role of matching the Radio frequency unit: because the operating impedances of the radio frequency unit and the telescopic antenna are different, L1 can match the impedance of the Radio frequency unit and the impedance of the telescopic antenna, which ensures the normal operation of the both, so as to achieve the reception and transmission of the wireless signal.

Step 102 will be illustrated in detail in combination with FIG. 3 hereinafter. As shown in FIG. 3, when the telescopic antenna is retracted, the telescopic antenna is connected with the feedback signal contact, and at this time, the GPIO interface is connected with the telescopic antenna through the feedback signal contact according to the conductive properties of metal materials of the telescopic antenna, so as to be connected with the antenna feed point, and is connected with the ground according to the direct-current conductive properties of the L1 inductor, and then the GPIO interface is in a low level state, and at this time, the feedback signal contact is also in a low level state. The control unit is disconnected from the Radio frequency unit according to the low level state of the GPIO interface, and at this time, the Radio frequency unit will no longer interact with the control unit by the low frequency signal and perform transformation of the high frequency signal, i.e., the Radio frequency unit is in a closing state, which saves the power consumption of the Radio frequency unit; accordingly, at this time, the terminal performs standby or off processing instead of the transmission and reception of the wireless signal.

Thus, in the solution of power saving of the present invention, the Radio frequency unit is open and transmits and receives the wireless signal through the telescopic antenna when the telescopic antenna is pulled out; and when the telescopic antenna is retracted, the Radio frequency unit is closed and the terminal is also in a standby or off state, which can minimize the power consumption of the Radio frequency unit, so as to save the battery power of the terminal.

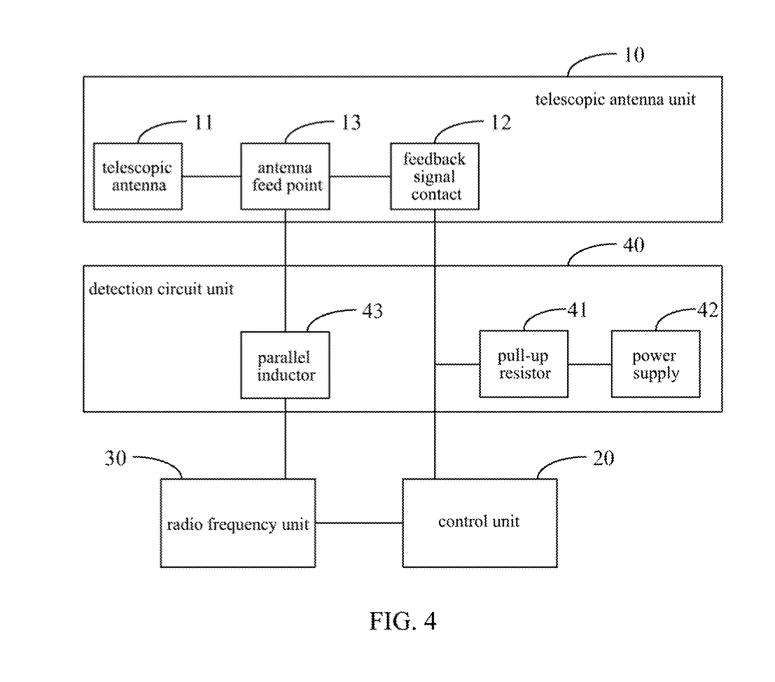

In order to achieve the above method for saving power, the present invention provides a terminal as shown in FIG. 4, which comprises a telescopic antenna 11, a control unit 20 and a radio frequency unit 30, wherein,

the telescopic antenna 11 is used to generate a pulled-out or retraction state;

the control unit 20 is used to be connected with or disconnected from the radio frequency unit 30 according to the pulled-out or retraction state of the telescopic antenna 11; and

the radio frequency unit 30 is used to be connected with or disconnected from the control unit 20.

The terminal further comprises a detection circuit unit 40 and a feedback signal contact 12.

The detection circuit unit 40 is used to output a high level to a GPIO interface of the control unit 20 continually.

The feedback signal contact 12 is connected with the GPIO interface of the control unit 20. The feedback signal contact 12 is used to be disconnected from the telescopic antenna 11 when the telescopic antenna 11 is in a pulled-out state and be in a high level state together with the GPIO interface; and to be connected with the telescopic antenna 11 when the telescopic antenna 11 is in a retraction state, and be in a low level state together with the GPIO interface.

The telescopic antenna 11 and the feedback signal contact 12 are located at the telescopic antenna unit 10.

The detection circuit unit 40 further comprises: a pull-up resistor 41 and a power supply 42.

The power supply 42 outputs a high level to the GPIO interface through the pull-up resistor 41 continually.

The detection circuit unit 40 further comprises: a parallel inductor 43; the telescopic antenna unit 10 further comprises: an antenna feed point 13; the parallel inductor 43 is connected with the antenna feed point 13; and the antenna feed point 13 is connected with the telescopic antenna 11.

The parallel inductor 43 is used to match the operating impedances of the telescopic antenna 11 and the radio frequency unit 30 and achieve the interaction between the radio frequency unit 30 and the telescopic antenna 11 by a high frequency signal through the antenna feed point 13, when the telescopic antenna 11 is in the pulled-out state; the parallel inductor 43 and the antenna feed point 13 are used to achieve the connection between the GPIO interface and the ground when the telescopic antenna 11 is in the retraction state.

The control unit 20 is further used to be connected with or disconnected from the radio frequency unit 30 according to the high level or low level state of the GPIO interface.

The radio frequency unit 30 is further used to become into an opening state and interact with the telescopic antenna 11 by the high frequency signal when it is connected with the control unit 20, and become into a closing state when it is disconnected from the control unit 20.

Accordingly, the telescopic antenna 11 is further used to transform the received high frequency signal into a wireless signal for transmission when the radio frequency unit 30 becomes into an opening state, and is further used to transform the received wireless signal into a high frequency signal and provide it to the radio frequency unit 30.

The above description is only the preferred embodiments of the present invention and is not intended to limit the protection scope of the present invention.

What is claimed is:

1. A terminal, comprising: a telescopic antenna, a control unit and a radio frequency unit, wherein,
the telescopic antenna is used to generate a pulled-out or retraction state;
the control unit is used to be connected with or disconnected from the radio frequency unit according to the pulled-out or retraction state of the telescopic antenna; and
the radio frequency unit is used to be connected with or disconnected from the control unit.

2. The terminal according to claim 1, further comprising a detection circuit unit and a feedback signal contact, wherein,
the detection circuit unit is used to output a high level to a programming controllable input and output (GPIO) interface of the control unit;
the feedback signal contact is connected with the GPIO interface of the control unit; and is used to be disconnected from the telescopic antenna and be in a high level state together with the GPIO interface when the telescopic antenna is in the pulled-out state, and to be connected with the telescopic antenna and be in a low level state together with the GPIO interface when the telescopic antenna is in the retraction state; and
the telescopic antenna and the feedback signal contact are located at the telescopic antenna unit.

3. The terminal according to claim 2, wherein, the detection circuit unit further comprises a pull-up resistor and a power supply,
the power supply outputs a high level to the GPIO interface through the pull-up resistor.

4. The terminal according to claim 2, wherein, the detection circuit unit further comprises a parallel inductor, and the telescopic antenna unit further comprises an antenna feed point,
the parallel inductor is connected with the antenna feed point, and the antenna feed point is connected with the telescopic antenna;
the parallel inductor is used to match operating impedances of the telescopic antenna and the radio frequency unit and achieve an interaction between the radio frequency unit and the telescopic antenna by a high frequency signal through the antenna feed point when the telescopic antenna is in the pulled-out state; and the parallel inductor and the antenna feed point are used to achieve a connection between the GPIO interface and ground when the telescopic antenna is in the retraction state.

5. The terminal according to claim 1, wherein,
the control unit is further used to be connected with or disconnected from the radio frequency unit according to the high level or low level state of the GPIO interface;
the radio frequency unit is further used to become into an opening state and interact with the telescopic antenna by the high frequency signal when being connected with the control unit; and become into a closing state when being disconnected from the control unit; and
accordingly, the telescopic antenna is further used to transform received high frequency signal into a wireless signal for transmission when the radio frequency unit becomes into the opening state; and is further used to transform received wireless signal into a high frequency signal to provide to the radio frequency unit.

6. A method for saving power of terminal, comprising:
a control unit being connected with a radio frequency unit when a telescopic antenna is in a pulled-out state; and
the control unit being disconnected from the radio frequency unit when the telescopic antenna is in a retraction state.

7. The method for saving power of terminal according to claim 6, further comprising:
a power supply of a detection circuit unit outputting a high level to a GPIO interface of the control unit through a pull-up resistor continually;
accordingly, when the telescopic antenna is in the pulled-out state, the method further comprising: the telescopic antenna being disconnected from a feedback signal contact, and the GPIO interface and the feedback signal contact connected therewith being in a high level state; and
when the telescopic antenna is in the retraction state, the method further comprising: the telescopic antenna being connected with the feedback signal contact, and the GPIO interface and the feedback signal contact connected therewith being in a low level state.

8. The method for saving power of terminal according to claim 7, wherein, the GPIO interface and the feedback signal contact being in the low level state specifically is that
the GPIO interface is connected with the telescopic antenna through the feedback signal contact according to conductive properties of metal materials of the telescopic antenna when the telescopic antenna is connected with the feedback signal contact; and is connected with ground through a antenna feed point connected with the telescopic antenna according to direct-current conductive properties of a parallel inductor in the detection circuit unit, and then the GPIO interface and the feedback signal contact are in a low level state.

9. The method for saving power of terminal according to claim 7, wherein, the control unit being connected with the radio frequency unit specifically is that the control unit is connected with the radio frequency unit according to the high level state of the GPIO interface.

10. The method for saving power of terminal according to claim 9, wherein, after the control unit is connected with the radio frequency unit, the method further comprises: opening the radio frequency unit;
accordingly, the radio frequency unit transforming a low frequency signal provided by the control unit into a high frequency signal to provide to the telescopic antenna, and the telescopic antenna transforming the high frequency signal into a wireless signal for transmission; or
the telescopic antenna transforming received wireless signal into a high frequency signal to provide to the radio frequency unit, and the radio frequency unit transforming the high frequency signal into a low frequency signal to provide to the control unit for processing.

11. The method for saving power of terminal according to claim 10, wherein, the radio frequency unit providing the high frequency signal to the telescopic antenna or the telescopic antenna providing the high frequency signal to the radio frequency unit specifically is that
after the parallel inductor of the detection circuit unit matches operating impedances of the telescopic antenna and the radio frequency unit, the radio frequency unit providing the high frequency signal to the telescopic antenna through the antenna feed point connected with the telescopic antenna, or the telescopic antenna providing the high frequency signal to the radio frequency unit through the antenna feed point.

12. The method for saving power of terminal according to claim 7, wherein, the control unit being disconnected from the radio frequency unit specifically is that the control unit is disconnected from the radio frequency unit according to the low level state of the GPIO interface.

13. The method for saving power of terminal according to claim 12, wherein, after the control unit is disconnected from the radio frequency unit, the method further comprises: closing the radio frequency unit.

14. The terminal according to claim 2, wherein,
the control unit is further used to be connected with or disconnected from the radio frequency unit according to the high level or low level state of the GPIO interface;
the radio frequency unit is further used to become into an opening state and interact with the telescopic antenna by the high frequency signal when being connected with the control unit; and become into a closing state when being disconnected from the control unit; and
accordingly, the telescopic antenna is further used to transform received high frequency signal into a wireless signal for transmission when the radio frequency unit becomes into the opening state; and is further used to transform received wireless signal into a high frequency signal to provide to the radio frequency unit.

15. The terminal according to claim 3, wherein,
the control unit is further used to be connected with or disconnected from the radio frequency unit according to the high level or low level state of the GPIO interface;
the radio frequency unit is further used to become into an opening state and interact with the telescopic antenna by the high frequency signal when being connected with the control unit; and become into a closing state when being disconnected from the control unit; and
accordingly, the telescopic antenna is further used to transform received high frequency signal into a wireless signal for transmission when the radio frequency unit becomes into the opening state; and is further used to transform received wireless signal into a high frequency signal to provide to the radio frequency unit.

16. The terminal according to claim 4, wherein,
the control unit is further used to be connected with or disconnected from the radio frequency unit according to the high level or low level state of the GPIO interface;
the radio frequency unit is further used to become into an opening state and interact with the telescopic antenna by the high frequency signal when being connected with the control unit; and become into a closing state when being disconnected from the control unit; and
accordingly, the telescopic antenna is further used to transform received high frequency signal into a wireless signal for transmission when the radio frequency unit becomes into the opening state; and is further used to transform received wireless signal into a high frequency signal to provide to the radio frequency unit.

17. The method for saving power of terminal according to claim 8, wherein, the control unit being disconnected from the radio frequency unit specifically is that the control unit is disconnected from the radio frequency unit according to the low level state of the GPIO interface.
